(19) United States
(12) Patent Application Publication
(10) Pub. No.: US 2006/0123450 A1
(43) Pub. Date: Jun. 8, 2006

(54) Method of creating vobu in hd-dvd system

(76) Inventors: Gongming Wei, Shanghai (CN); Bei Wang, Shanghai (CN); Fons Bruls, Eindhoven (NL)

Correspondence Address: Philips Electronics North America Corporation;Corporate Patent Counsel, P O Box 3001, Briarcliff Manor, NY, 10510, US

(21) Appl. No.: 10/541,050

(22) PCT Filed: Dec. 22, 2003
(86) PCT No.: PCT/IB03/06225

§ 371 Date: Jan. 17, 2006

(30) Foreign Application Priority Data
Dec. 30, 2002 (CN) 021604606

(51) Int. Cl. H04N 7/18; H04N 7/173

(52) U.S. Cl. 725/74; 725/100; 725/131

(57) ABSTRACT

Disclosed is a method of creating video object units (VOBU) in high-definition DVD (HD-DVD) systems. HD enhanced data in the form of data packets are multiplexed and stored with standard-definition (SD) data in a VOBU. In the VOBU, the spa ce where the video pocket (V-PCK) and the for SD data related video packet (V-P CK-HD) for HD-enhanced data are stored is shortened as possible. This will increase the efficiency of a future enhanced DVD video player that supports the HD-DVD optical disc format to fetch, decode and synchronize the SD and HD enhanced data. Furthermore, the optical disc created in this kind of data storing has good backward compatibility.

### TECHNICAL FIELD

The present invention relates generally to HD-DVD technology. More particularly, the present invention relates to a method of creating VOBU in HD-DVD system.

### BACKGROUND OF THE INVENTION

Recent years, DVD video has got great success in market, and people more and more interest in high definition standard. The present DVD video optical disc hold the video with the definition of 720*480 @ 29.94 Hz or 720*576 @ 25 Hz, which is called SD (Standard Definition) video data stream in this article. The enhanced DVD optical disc can hold the video with the definition of 1280*720 or even 1920*1080, which is called HD (High Definition) video data stream in this article. If the same compressing technology is used, the video with higher quality will need the program streams having higher code rate and/or bit rate. It means that the storage of single side optical disc must be increased for playing the same length (135 minutes) video. These will require updating not only optical disc manufacture technology, but also diver technology. For these indirect influences, it is impossible to get the backward compatibility between the new DVD player and the traditional DVD player.

But, when the video bit rate is equal to the bit rate of the present double side SD-DVD optical disc, the HD video quality can be realized by using new video data compressing technology, instead of updating the optical disc manufacture technology. If this resolve method is used, the present optical disc product line can produce HD optical disc. Furthermore, the present DVD optical disc driver can still be used in HD-DVD video player. So it is only needed to update the making process of DVD content, or the program streams encoding system in tools and the decoding IC of player. However, the final HD-DVD optical disc is still not compatible with the present DVD video player.

The enhanced optical disc can achieve the backward compatibility by dividing HD video data stream into 2 logical layers. One layer contains SD video data that is compatible with the present DVD player. The other contains the enhanced video data, which is called HD-enh video data in this article.

In order that the generated HD-DVD optical disc has better compatibility, a key principle must be insisted when generating HD-DVD optical disc based on HD-enh video data streams and SD video data streams. The principle is to ensure that the generated HD-DVD optical disc can be played smoothly both on the present DVD video player and the future HD-DVD video player. Under this principle, SD data and the related HD-enh data should be stored systematically in the optical disc. Or, when HD-DVD optical disc is being played, there will be some problems in fetching, decoding, and synchronizing the SD and HD-enh video data in optical disc in future HD-DVD video player. And it will also affect the playing effect of HD-DVD disc in the present DVD player.

So, the present invention provides a method to create VOBU in HD-DVD system.

### SUMMARY OF THE INVENTION

The goal of the present invention is to provide a method of creating VOBU in HD-DVD system, which can improve the efficiency of future enhanced DVD video player that supports HD-DVD optical disc format to fetch, decode and synchronize SD and HD-enh date. Furthermore, the discs produced with this method have good backward compatibility.

The method of creating VOBU in HD-DVD systems introduced in the present invention comprises the following steps:

a. gain HD-enh data streams and SD video data streams by dividing original HD video data streams;

b. all kinds of data streams including HD-enh video data streams, SD video data streams, and audio data streams are packed to HD-enh video data packet (V_PCK_HD), video data packet (V_PCK), and audio data packet (A_PCK) respectively to compose a series of VOBUs.

V_PCK_HD data packet and related V_PCK data packet are sequenced adjacently in the same VOBU. V_PCK_HD data packet and V_PCK data packet can share the same A_PCK data packet in VOBU.

HD-enh video data streams are packed to V_PCK_HD packet according to the defined structure of the V_PCK_HD data packet in said step b. The structure of the V_PCK_HD data packet can be defined with a reserved Stream_ID, namely the identification mark of the stream, in MPEG standards. And the structure can also be defined with a reserved or provider defined Sub_Stream_ID, namely the identification mark of the sub-stream, after putting HD-enh video data into private data stream.

The data in VOBU can be written into optical disc in turn to create a HD-DVD disc. And the mapping files created by a series of VOBUs can also make the HD-DVD disc. HD-DVD disc contains V_PCK_HD data packets.

Means for creating VOBU in HD-DVD systems, comprising:

A segregating unit, used to divide original HD video data streams into HD-enh data streams and SD video data streams;

A multiplexer, used to pack all kinds of input data streams including HD-enh video data streams, SD video data streams, and audio data streams into HD-enh video data packets (V_PCK_HD), video data packets (V_PCK), and audio data packets (A_PCK) respectively composing a series of VOBUs; and the segregating unit is joined with the multiplexer. The multiplexer is conformed to DVD standards.

The segregating unit comprises: a means for resolution downgrade, used to downgrade the resolution of the input original HD video data streams; a SD encoder, used to encode the input data streams which have been resolution-downgraded to gain SD video data streams, and transmit the SD video data streams to multiplexer; a decoder, used to decode the input SD video data streams; a means for resolution upgrade, used to upgrade the resolution of the input decoded SD video data streams; a differential means, used to perform differential process on the input original HD video data streams and the input data streams which have been resolution-upgraded; a HD-enh encoder, used to encode the data streams which have been differentiated to gain HD-enh video data streams, and transmit the HD-enh video data streams to the multiplexer.

A means for playing HD-DVD disc, comprising:

An optical wave picker, used to deal with the input VOBU data streams in the HD-DVD disc to gain V_PCK_HD data packet and V_PCK data packet; a HD-DVD decoder, used to respectively decode the V_PCK_HD data packet and V_PCK data packet to gain HD-enh video data streams and SD video data streams; a means for resolution upgrade, used to upgrade the resolution of the input SD video data streams; a means for overlapping, used to overlap the input SD video data streams which have been resolution upgraded with the input HD-enh video data streams to gain the output of the high definition TV.

The HD-DVD decoder said above contains a V_PCK_HD buffer, a V_PCK buffer, a HD-enh decoder and a SD decoder, V_PCK_HD buffer and HD-enh decoder process the input V_PCK_HD packet in turn to gain HD-enh video data streams, and V_PCK buffer and SD decoder deal with the input V_PCK packet in turn to gain SD video data streams.

The present invention will take huge advantage to HD-DVD disc. Because the same moments' SD video data and the related HD-enh video data are saved in the same VOBU in HD-DVD disc, so the future HD-DVD player can fetch, decode and synchronize SD and HD-enh data easily. The HD-DVD disc produced under the method introduced in the present invention will have good backward compatibility. Because the present DVD player cannot identify the additional HD-enh video data packets (V_PCK_HD), it can play HD-DVD disc successfully by skipping these V_PCK_HD data packets. Furthermore, the method in the present invention can decrease the technical difficulties in transiting from the present DVD player to HD-DVD player.

### BRIEF DESCRIPTION OF THE DRAWINGS

The invention is explained in further detail, and by way of example, with reference to the accompanying drawings wherein:

FIG. 1 is a diagram showing the said means in the present invention for creating VOBU in HD-DVD systems.

FIG. 2 is a diagram showing the main cycle of the multiplexing access of the present standard DVD multiplexer.

FIG. 3 is a diagram showing the first defining way of the structure of V_PCK_HD data packet said in the present invention.

FIG. 4 is a diagram showing the second defining way of the structure of V_PCK_HD data packet said in the present invention.

FIG. 5 is a diagram showing the VOBU structure with V_PCK_HD data packets created by the said method in the present invention.

FIG. 6 (a) is a diagram showing the part structure of the present SDTV player.

FIG. 6 (b) is a diagram showing the part structure of the HDTV player in the present invention.

### DETAILED DESCRIPTION OF THE EMBODIMENT

Further description is given below referencing to the examples and drawings.

The method of creating VOBU in HD-DVD systems introduced in the present invention comprises the following steps:

a. gain HD-enh data streams and SD video data streams by dividing original HD video data streams;

b. all kinds of data streams including HD-enh video data streams, SD video data streams, and audio data streams are packed to HD-enh video data packet (V_PCK_HD), video data packet (V_PCK), and audio data packet (A_PCK) respectively to compose a series of VOBUs.

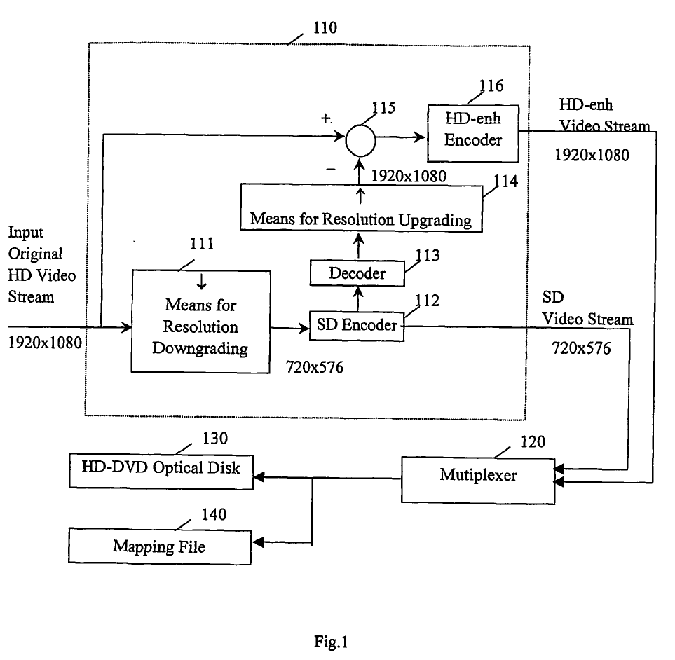

FIG. 1 shows the said means in the present invention for creating VOBU in HD-DVD systems. Take the HD original data stream which having the definition 1920*1080 as example.

First, as shown in FIG. 1, the segregating unit 110 divides the input HD original video data streams into HD-enh video data streams and SD video data streams. The embodiment of this process is shown as following. Make the input HD original data streams with the definition 1920*1080 transit the means for resolution downgrade 111 and SD encoder 112 in turn to downgrade the resolution and encode the downgraded data, so as to get the SD video data streams with the definition 720*576. Then, make the encoded SD video data streams with the definition 720*576 transit the decoder 113 and the means for resolution upgrade 114 in turn to decode and upgrade the resolution, so as to get the data streams with the definition 1920*1080. And then, carry on the differential process on the updated data streams and the input HD original video data streams by the differential means 115. Finally, encode the data streams that have been differentiated to get the HD-enh video data streams with the definition of 1920*1080 by the HD-enh encoder 116.

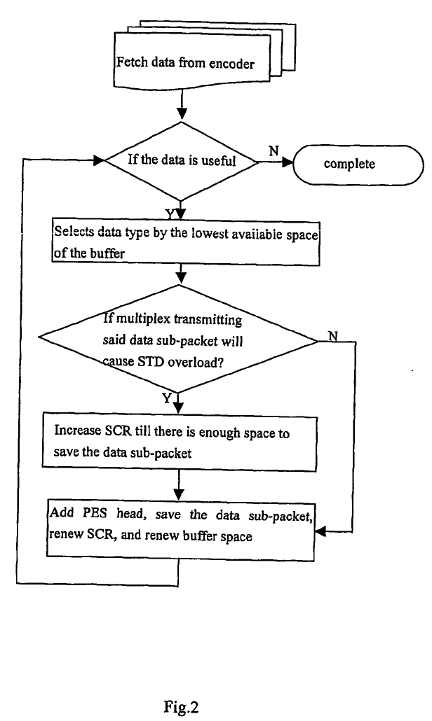

Second, as shown in FIG. 1, input the HD-enh video data streams and SD data streams divided by the segregating unit 110, and other processed data streams including assistant data streams, audio data streams, and sub-picture data streams into DVD multiplexer 120 together. FIG. 2 shows the main multiplexing access of present DVD multiplexers.

As shown in FIG. 2, first, DVD multiplexer fetches all kinds of input data including HD-enh video data streams, SD video data streams, and audio data streams from encoder. Then, the multiplexer judges if the data is useful, if not, completes the operation; otherwise, selects data type by the lowest available space of the buffer. After deciding the data type, the multiplexer judges if multiplex transmitting the data sub-packets will cause system target decoder (STD) overload; If not, the multiplexer will add PES head, save the data sub-packets, renew SCR, renew buffer space, and then, continue to judge if the fetched data is useful and constitute a cycle; otherwise, it will increase SCR till there is enough space to save the data sub-packets, and then, add PES head, save the data sub-packets, renew SCR, renew buffer space, and then, continue to judge if the fetched data is useful and constitute a cycle.

Third, as shown in FIG. 1, the DVD multiplexer 120 packs all kinds of input data streams including HD-enh video data streams, SD video data streams, assistant data streams, audio data streams, and sub-picture data streams into HD-enh video data packet (V_PCK_HD), video data packet (V_PCK), assistant video data packet (NV_PCK), audio data packet (A_PCK), and sub-picture data packet (SB_PCK) respectively to compose a series of VOBUs, namely VOB files. Said V_PCK_HD data packets and related V_PCK data packets are sequenced adjacently in the same VOBU.

DVD multiplexer 120 packs HD-enh video data packets according to the structure of V_PCK_HD defined above, so that the HD-DVD player can identify the HD-enh video data while playing the video.

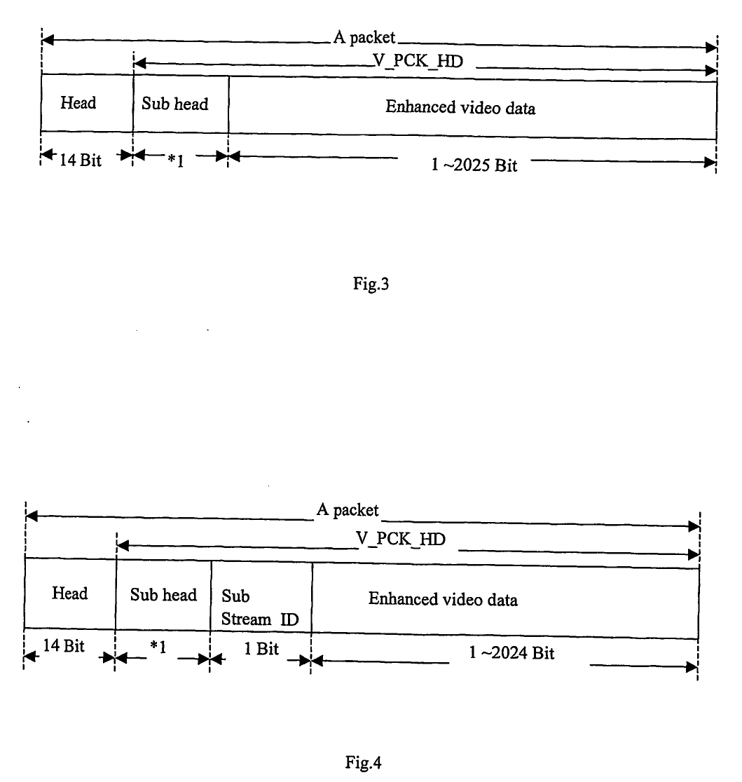

There are some different ways to define the structure of V_PCK_HD data packet. For example, we can define the structure of V_PCK_HD data packet by the reserved Stream_ID (the identification mark of the stream) in MEPG standards. This is shown in FIG. 3.

FIG. 3 shows the first way to define V_PCK_HD data packet in the present invention. As FIG. 3 shown, except the Stream_ID, the structure definitions of V_PCK_HD data packet are all same as SD video data packet. In other words, we use 0xFA to identify the V_PCK_HD packet containing HD-enh data, just like using 0xE0 to identify SD video data packet (V_PCK). Namely:

V_PCK_HD data packet . . . Stream_ID: 1111 1010b (0xFA: reserved in MPEG standards)

Another way is putting HD-enh video data into private stream to define the structure of V_PCK_HD data packet by a reserved or provider defined Sub_Stream_ID, namely the identification mark of the sub-stream, as shown in FIG. 4.

FIG. 4 shows the second way to define V_PCK_HD data packet in the present invention. As FIG. 4 shown, except the Sub_Stream_ID (the identification mark of the sub-stream), the structure definitions of V_PCK_HD data packet are all same as SD sub-picture data packet. In other words, we use Sub_Stream_ID (the identification mark of the sub-stream) 0xFF to identify the V_PCK_HD packet containing HD-enh data, just like using Stream_ID to identify it in SD sub-picture data packet. Namely:

V_PCK_HD data packet . . . . Stream_ID: 1011 1101b (0xBD: Private_Stream_{—}1)

Sub_Stream_ID: 1111 1111b (0xFF: provider defined stream)

In FIG. 4, “*1” represents that the magnitude of the sub-packet head of V_PCK_HD data packet is defined equally to the sub-packet head of SD V_PCK.

Of course, the structure of V_PCK_HD data packet can also be defined by other ways.

Furthermore, the number of V_PCK_HD data packets and V_PCK data packets is not fixed even in the same VOBU. The number of V_PCK_HD data packets and V_PCK data packets depends on the bit rate of the whole data stream, the bit rate of every input data stream, and the magnitude of every stream buffer using in multiplexing access.

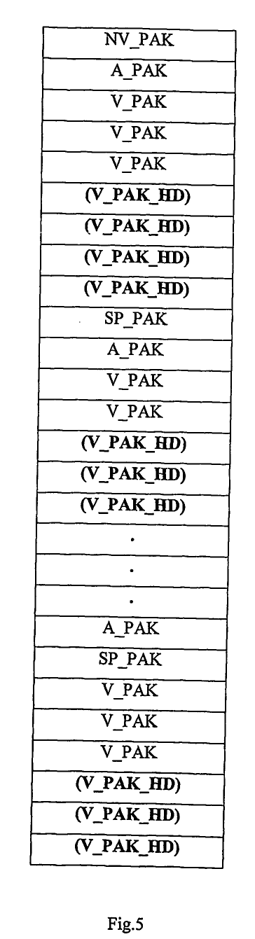

FIG. 5 shows the structure of VOBU containing V_PCK_HD data packets generated by the method introduced in the present invention. As shown in FIG. 5, NV_PCK data packet, A_PCK data packet, SP_PCK data packet, and V_PCK data packet represent the navigation data packet audio data packet, sub-picture data packet, and video data packet in SD-DVD video respectively. V_PCK_HD data packet represents the video data packet containing HD-enh data. Mostly, V_PCK_HD data packet and V_PCK data packet share the same A_PCK data packet. V_PCK_HD data packet and V_PCK data packet can also sometimes share the same NV_PCK data packet and SP_PCK data packet, and the NV_PCK data packet can be changed according to the requests of HD video navigation. Compared with the VOBU structure of the present DVD video, the present invention inserts HD-enh video data packet (V_PCK_HD data packet) related to SD V_PCK data packet into VOBU.

Finally, as shown in FIG. 1, said all kinds of data in the VOBU shown in FIG. 5 containing HD-enh video data can be written into a DVD optical disc in turn to create the HD-DVD disc 130. The V_PCK_HD data packet and related V_PCK data packet in HD-DVD disc 130 are sequenced adjacently in the same VOBU, so that the optical disc has good backward compatibility.

Another way is to generate the mapping file 140 by a series of said VOBUs shown in FIG. 5 to make large number HD-DVD discs.

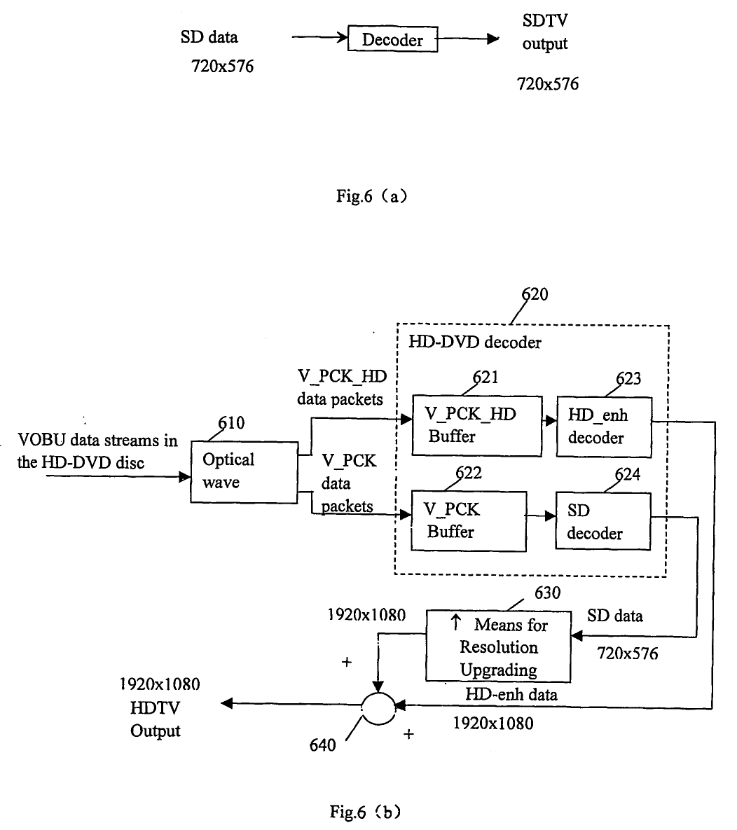

FIG. 6 (a) shows the part structure of the present SDTV player. Taking the SD data stream with the definition 720*576 as example, as shown in FIG. 6 (a), the SDTV output with the definition 720*576 can be achieved just by decoding the SD video data streams with the definition 720*576.

FIG. 6 (b) shows the part structure of the HDTV player in the present invention. Taking the SD data stream with the definition 720*576 and the HD-enh video data stream with the definition 1920*1080 as example, as shown in FIG. 6 (b), the optical wave picker 610 deals with the input VOBU data streams in the HD-DVD disc to gain V_PCK_HD data packets and V_PCK data packets; the HD-DVD decoder 620 decodes the V_PCK_HD data packets and V_PCK data packets respectively to gain the HD-enh video data streams whose definition is 1920*1080 and the SD video data streams whose definition is 720*576; the resolution upgrading means 630 upgrades the resolution of the input SD video data streams to get the HD video data stream with the definition 1920*1080; the overlapping means 640 overlaps the input SD video data streams whose resolution have been upgraded with the input HD-enh video data streams to gain the output of HDTV (high definition TV).

Said HD-DVD decoder 620 contains the V_PCK_HD buffer 621, the V_PCK buffer 622, the HD-enh decoder 623 and the SD decoder 624. The V_PCK_HD buffer 621 and the HD-enh decoder 623 process the input V_PCK_HD packets in turn to get HD-enh video data streams with the definition 1920*1080, the V_PCK buffer 622 and the SD decoder 624 deal with the input V_PCK packets in turn to get SD video data streams with the definition 720*576.

Other devices using in HDTV player are not shown in FIG. 6 (b), because all those devices adopt the present technologies.

According to the present invention, we test the backward compatibility of the optical disc produced under the method introduced in the present invention by making HD-DVD discs using HD data streams with different code rate. We have improved the present DVD disc manufacture tools and produced the mapping file of HD-DVD disc, then copied the mapping file into DVD+RW disc and played it by the present DVD player. Because the present DVD player cannot identify either the Stream_ID (the first structure defining way) or the Sub_Stream_ID (the second structure defining way), so the present DVD player will skip the HD-enh video data and play SD video data only. According to the following table, we can find said HD-DVD disc has good backward compatibility. However, too high HD video bit rate affects the fluency of video and audio playing in some degree.

TABLE 1
shows the test result of playing HD-DVD disc produced with
the method in the present invention in the present DVD player.

| | Bit rate (average | Test result in the |
|---|---|---|
| Code Stream | bit rate) | present DVD player |
| Standard stream | 8.8 Mbps | |
| Test stream 1 | 11.7 Mbps | No affection |
| Test stream 2 | 13.2 Mbps | No affection |
| Test stream 3 | 17.6 Mbps | Not very fluently |

1. A method of creating VOBU in HD-DVD systems, comprising following steps:
a. gain HD-enh data streams and SD video data streams by dividing original HD video data streams;
b. all kinds of data streams including HD-enh video data streams, SD video data streams, and audio data streams are packed to HD-enh video data packet (V_PCK_HD), video data packet (V_PCK), and audio data packet (A_PCK) respectively to compose a series of VOBUs.

2. The method of claim 1, further comprising a step of writing the data in the VOBU into an optical disc in turn to create a HD-DVD disc.

3. The method of claim 1, further comprising a step of creating mapping file by a series of VOBUs to make HD_DVD disc.

4. The method of claim 2 or claim 3, wherein said V_PCK_HD data packet and related V_PCK data packet are sequenced adjacently in the same VOBU.

5. The method of claim 1, wherein said V_PCK_HD data packet and said V_PCK data packet can share the same A_PCK data packet in the VOBU.

6. The method of claim 1, wherein the HD-enh video data streams are packed to V_PCK_HD packet according to the defined structure of the V_PCK_HD data packet in said step b.

7. The method of claim 6, wherein the structure of the V_PCK_HD data packet is defined with a reserved Stream_ID, namely the identification mark of the stream, in MPEG standards.

8. The method of claim 6, wherein the HD-enh video data is put into the private stream, and the structure of the V_PCK_HD data packet is defined with a reserved or provider defined Sub_Stream_ID, namely the identification mark of the sub-stream.

9. A kind of HD-DVD disc, wherein said disc contains V_PCK_HD data packet and V_PCK data packet.

10. The HD-DVD disc of claim 9, wherein said V_PCK_HD data packet and related V_PCK data packet are sequenced adjacently in the HD-DVD disc.

11. Means for creating VOBU in HD-DVD systems, comprising:
a segregating unit, used to divide original HD video data streams into HD-enh data streams and SD video data streams;
a multiplexer, used to pack all kinds of input data streams including HD-enh video data streams, SD video data streams, audio data streams into HD-enh video data packet (V_PCK_HD), video data packet (V_PCK), audio data packet (A_PCK) respectively composing a series of VOBUs; and the said segregating unit is joined with the multiplexer.

12. The means of claim 11, wherein said segregating unit comprises:
Means for resolution downgrade, used to downgrade the resolution of the input original HD video data streams;
SD encoder, used to encode the input data streams which have been resolution-downgraded to gain SD video data streams, and transmit the SD video data streams to the multiplexer;
Decoder, used to decode the input SD video data streams;
Means for resolution upgrade, used to upgrade the resolution of the input decoded SD video data streams;
A differential means, used to perform differential process on the input data streams which have been resolution-upgraded and the input original HD video data streams;
HD-enh encoder, used to encode the data streams which have been differentiated to gain HD-enh video data streams, and transmit the HD-enh video data streams to the multiplexer.

13. The means of claim 11, wherein said multiplexer is the multiplexer which accords with DVD standards.

14. Means for playing HD-DVD disc, comprising:
optical wave picker, used to deal with the input VOBU data streams in the HD-DVD disc to gain V_PCK_HD data packet and V_PCK data packet;
HD-DVD decoder, used to respectively decode the V_PCK_HD data packet and V_PCK data packet to gain HD-enh video data streams and SD video data streams;
means for resolution upgrade, used to upgrade the resolution of the input SD video data streams;
means for overlapping, used to overlap the input SD video data streams which have been resolution upgraded with the input HD-enh video data streams to gain the output of the high definition TV.

15. The means of claim 14, wherein said HD-DVD decoder contains a V_PCK_HD buffer, a V_PCK buffer, a HD-enh decoder and a SD decoder, said V_PCK_HD buffer and the HD-enh decoder process the V_PCK_HD packet in turn to gain HD-enh video data streams, said V_PCK buffer and SD decoder deal with the V_PCK packet in turn to gain SD video data streams.
